(19) United States
(12) Patent Application Publication
(10) Pub. No.: US 2011/0103413 A1
(43) Pub. Date: May 5, 2011

(54) Quasi-continuous wave ultraviolet light source with optimized output characteristics

(75) Inventors: James D. Kafka, Palo Alto, CA (US); David E. Spence, Mountain View, CA (US)

(73) Assignee: Newport Corporation, Irvine, CA (US)

(21) Appl. No.: 12/009,423

(22) Filed: Jan. 18, 2008

Related U.S. Application Data
(60) Provisional application No. 60/881,350, filed on Jan. 19, 2007.

(51) Int. Cl. H01S 3/10

(52) U.S. Cl. 372/22; 372/9; 372/25

(57) ABSTRACT

The present application discloses various embodiments and methods of producing a quasi-CW UV laser system having the pulse duration and bandwidth to optimize harmonic conversion while producing a UV output configured to satisfy the constraints imposed by the optical system in optical communication therewith. More specifically, in one embodiment the present application discloses a method of optimizing at least one characteristic of the output of a laser system and includes providing a laser system having at least one spectral modification element in optical communication therewith, determining at least one optical characteristic of the output of the laser system for a given application, selecting the bandwidth of the output of the laser system to provide the determined characteristic, and adjusting the spectral modification element to provide the selected bandwidth.

### CROSS-REFERENCE TO RELATED APPLICATIONS

The present application claims priority to U.S. Provisional Patent Application Ser. No. 60/881,350, filed Jan. 19, 2007, the entire contents of which are hereby incorporated by reference in its entirety herein.

### BACKGROUND

Currently, a number of systems have been developed to provide quasi-continuous wave (hereinafter quasi-CW) ultraviolet radiation (hereinafter UV) radiation. One prior art system comprises a picosecond oscillator, a bulk amplifier, and a harmonic generator device positioned to produce a nearly transform limited quasi-CW UV output of about 8 W of average power having a bandwidth of about 20 pm to about 25 pm. While these systems have proven marginally successful in the past, a number of shortcomings have been identified. For example, higher average output powers have been difficult to achieve. One method of scaling these systems to higher average output powers requires the addition of multiple-bulk amplifiers, thereby increasing system complexity, size, and cost. As such, scaling to higher powers has proven cost prohibitive and time intensive.

In response to the shortcomings associated with multiple bulk amplifier systems, quasi-CW UV laser systems incorporating a fiber amplifier have been developed. Typically, these systems include a picosecond oscillator, a fiber amplifier, and a harmonic generator device configured to produce a desired UV output. While fiber-based quasi-CW UV lasers have proven useful in some applications in the past, a number of shortcomings have been identified. For example, the bandwidth of the infrared (hereinafter IR) seed pulses generated by the picosecond oscillator will increase due to a nonlinear effect called self-phase modulation (hereinafter SPM) inherent to the propagation of a high peak-power signal within a fiber optic device. As a result, the bandwidth of the IR signal is increased and the harmonic conversion efficiency of the quasi-CW UV laser can be reduced. Of course, other properties of the output may also be affected.

Often, quasi-CW UV laser sources are utilized in a number of applications. For example, quasi-CW UV lasers are frequently used for semiconductor wafer inspection, laser direct imaging, stereo lithography, material ablation, and various inspection applications. Generally, quasi-CW UV lasers include a picosecond oscillator, at least one optical amplifier, and at least one harmonic generator device. Often, the systems incorporating the quasi-CW UV laser include sophisticated optical systems. For example, laser direct imaging systems may include an optical system configured to focus the quasi-CW beam from the laser system to a small spot (i.e. about 1 micron to about 40 microns). Typically, the optical systems are complex and expensive to manufacture. Further, often these optical systems include one or more (possibly achromatic) lenses therein, which have proven difficult to manufacture for wavelengths of about 400 nm or less. As a result, the characteristics of the optical system (e.g. chromatic aberration) may place stringent requirements on the output of the quasi-CW UV laser. For example, the lens system may require the bandwidth of the UV radiation from the laser system to be less than about 50 pm, and preferably about 25 pm or less, to function optimally. As such, the pulse duration of the UV laser is selected to satisfy the constraints imposed by the optical system rather than the harmonic generator. As such, performance of the harmonic generator is typically not optimal.

In light of the foregoing, there is an ongoing need for a quasi-CW UV laser system having the pulse duration and bandwidth to optimize harmonic conversion while producing a UV output configured to satisfy the constraints imposed by the optical system in optical communication therewith.

### SUMMARY

The present application discloses various embodiments and methods of producing a quasi-CW UV laser system having the pulse duration and bandwidth to optimize harmonic conversion while producing a UV output configured to satisfy the constraints imposed by the optical system in optical communication therewith. More specifically, in one embodiment the present application discloses a method of optimizing at least one characteristic of the output of a laser system and includes providing a laser system having at least one spectral modification element in optical communication therewith, determining at least one optical characteristic of the output of the laser system for a given application, selecting the wavelength spectrum of the output of the laser system to provide the determined characteristic, and adjusting the spectral modification element to provide the selected wavelength spectrum.

In another embodiment, the present application is directed to a method of varying the output of a laser system and includes providing a laser system comprising at least one oscillator having at least one spectral modification element in optical communication therewith, selecting the pulse width of the output of the laser, and adjusting the position of the spectral modification element relative to an optical signal received from the oscillator to provide the selected pulse width.

In addition, the present application disclosed a laser device which includes at least one oscillator configured to output an oscillator signal having a first optical characteristic, at least one spectral modification element in optical communication with the oscillator and configured to receive the oscillator signal and output a modified signal having a modified optical characteristic, and at least one amplifier in communication with at least one of oscillator and the spectral modification element and configured to receive at least one of the oscillator signal and the modified signal, the amplifier configured output an amplified signal having a desired optical characteristic.

Other features and advantages of the embodiments of the quasi-CW UV laser systems having optimized output characteristics as disclosed herein will become apparent from a consideration of the following detailed description.

### BRIEF DESCRIPTION OF THE DRAWINGS

Various quasi-CW UV laser systems having an optimized output characteristics will be explained in more detail by way of the accompanying drawings, wherein

FIG. 1 shows a schematic diagram of an embodiment of a quasi-CW UV laser system having at least one spectral modification element positioned therein;

FIG. 2 shows an elevated perspective view of an embodiment of a spectral modification element for use within a quasi-CW UV laser system;

FIG. 3 shows a side view of an embodiment of a spectral modification element for use within a quasi-CW UV laser system;

FIG. 4 shows graphically the wavelength transmission spectrum of a spectral modification element positioned in a first orientation in a quasi-CW UV laser system;

FIG. 5 shows an elevated perspective view of spectral modification element rotated approximately 90 degrees relative to the longitudinal axis [symbol] thereof;

FIG. 6 shows graphically the wavelength transmission spectrum of a spectral modification element positioned in a second orientation shown in FIG. 5 in a quasi-CW UV laser system;

FIG. 7 shows an elevated perspective view of spectral modification element tilted such that an incident beam is non-normal relative to the longitudinal axis [symbol] thereof;

FIG. 8 shows graphically the wavelength transmission spectrum of a spectral modification element positioned in a tilted orientation shown in FIG. 7 in a quasi-CW UV laser system;

FIG. 9 show graphically the variation in pulsewidths of the output of a laser system incorporating various sizes of spectral modification elements as the spectral modification element is rotated about its longitudinal axis [symbol] and

FIG. 10 show graphically the variation in bandwidths of the output of a laser system incorporating various sizes of spectral modification elements as the spectral modification element is rotated about its longitudinal axis

[symbol]

### DETAILED DESCRIPTION

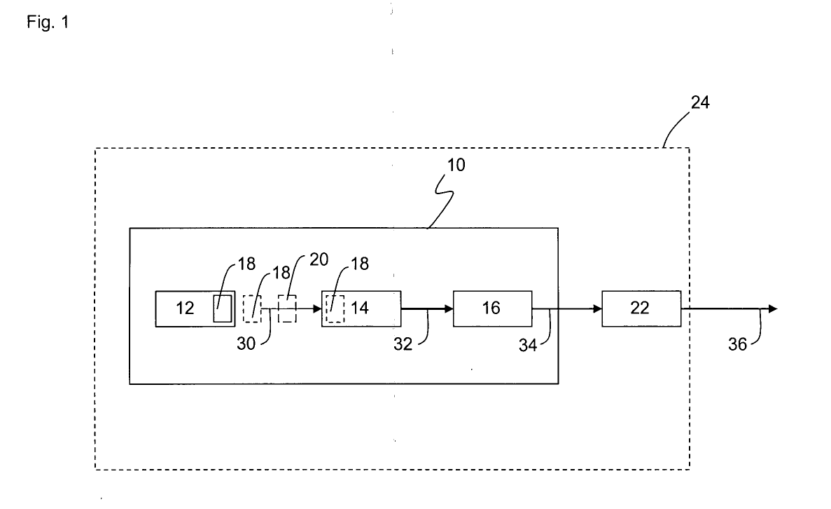

FIG. 1 shows an embodiment of a quasi-CW UV laser system. As shown, the laser system 10 comprises at least one oscillator device 12, at least one amplifier device 14, and at least one frequency conversion device 16. In the illustrated embodiment, the oscillator 12 comprises a picosecond oscillator although those skilled in the art will appreciate that any variety of oscillators may be used within the laser system 10. In other embodiments, the oscillator 12 may comprise a femtosecond oscillator. As an example of an embodiment that comprises a picosecond oscillator, in one such embodiment the oscillator 12 comprises a Vanguard™ laser manufactured by Spectra-Physics, a Division of Newport Corporation. As such, the oscillator 12 may comprise a diode-pumped Nd:Vanadate laser that is mode-locked and includes at least one SESAM (semiconductor saturable absorber mirror) and is configured to operate at a repetition rate of about 80 MHz. Those skilled in the art will appreciate that the oscillator device 12 may be configured to operate at any desired repetition rate, pulse duration, and wavelength. In the alternative, the oscillator device 12 may comprise a diode laser, a diode pumped solid state laser, a gas laser, a disk laser, a slab laser, a VCSEL laser, an alkali laser, a silicon laser, a fiber laser, and the like. Diode-pumped solid-state lasers may be constructed from any variety and combination of gain materials, including, without limitation, Ti:sapphire, Nd:YVO₄, Gd:YVO₄, Nd:YAG, Nd:YLF, Nd:Glass, Cr:YAG, Cr:Forsterite, Yb:YAG, Yb:glass, Yb:KGW, Yb:KYW, KYbW, YbAG, apatite structure crystals, and the like. Optionally, the oscillator device 10 may comprise any variety of laser devices. For example, the laser system need not be a modelocked, quasi-CW UV laser system. Exemplary alternate laser systems include, without limitation: CW laser systems, Q-switched laser systems, single frequency laser systems, OPOs, and the like. It will also be apparent that the laser system of FIG. 1 need not include a nonlinear frequency conversion device.

Referring again to FIG. 1, in one embodiment the amplifier device 14 comprises a fiber amplifier. Optionally, the amplifier device 14 may comprise a bulk amplifier. Further, the amplifier device 14 may comprise any variety of alternate laser amplifiers. In another embodiment, the amplifier device 14 may comprise multiple amplifiers. For example, the amplifier device 14 may comprise multiple fiber amplifiers or bulk amplifiers. Optionally, the amplifier device 14 may comprise both fiber and bulk amplifiers. Exemplary bulk amplifiers may be constructed from any variety and combination of gain materials, including without limitation, Ti:sapphire, Nd:YVO₄, Gd:YVO₄, Nd:YAG, Nd:YLF, Nd:Glass, Cr:YAG, Cr:Forsterite, Yb:YAG, Yb:glass, Yb:KGW, Yb:KYW, KYbW, YbAG, apatite structure crystals, and the like. Other amplifiers can include bulk waveguide amplifiers, fiber amplifiers, semiconductor amplifiers, and the like. A combination of bulk amplifiers, bulk waveguide amplifiers, fiber amplifiers, and semiconductor amplifiers can also be used.

As shown in FIG. 1, the laser system 10 includes at least one frequency conversion device 16. In one embodiment, the frequency conversion device 16 includes one or more optical materials configured to output a harmonic frequency of an input incident thereon. For example, in the illustrated embodiment, the harmonic conversion device 16 includes a second harmonic generator (SHG) and a third harmonic generator (THG) therein. As such, an incident signal having of a wavelength of about 1064 nm would be converted to a third harmonic wavelength of about 355 nm using a sum frequency mixing process known in the art. Those skilled in the art will appreciate that any number of harmonic generators may be used within the frequency conversion device 16 to produce a desired output. For example, fourth, fifth, and sixth harmonic frequencies of the input signal may be produced by adding additional harmonic generators to the frequency conversion device 16. The frequency conversion device 16 can also include one or a combination of frequency conversion devices such as harmonic generators, optical-parametric generators, optical-parametric oscillators, difference-frequency mixers, sum-frequency mixers, and the like. Any variety of materials may be used as harmonic generators within the frequency conversion device 16. For example, LBO, non-critically phase matched LBO, LiNbO₃, LiTaO₃, BBO, BiBO, CLBO, KTP, KTA, RTA, CTA, KDP, AgGaSe₂, AgGaS₂, PPLN, PPLT, PPSLT, and aperiodically poled materials, may be used. More generally, any variety and combination of frequency conversion devices 16 may be used including, without limitation, harmonic conversion devices, parametric conversion devices, continuum generators, nonlinear conversion devices, THz generators, atomic and molecular gasses and plasmas, and the like. In an alternate embodiment, the frequency conversion device 16 may output the fundamental frequency provided by the oscillator 12 or amplifier 14. Optionally, the frequency conversion device 16 may provide any combination of output frequencies provided by oscillator 12, amplifier 14 and frequency conversion device 16.

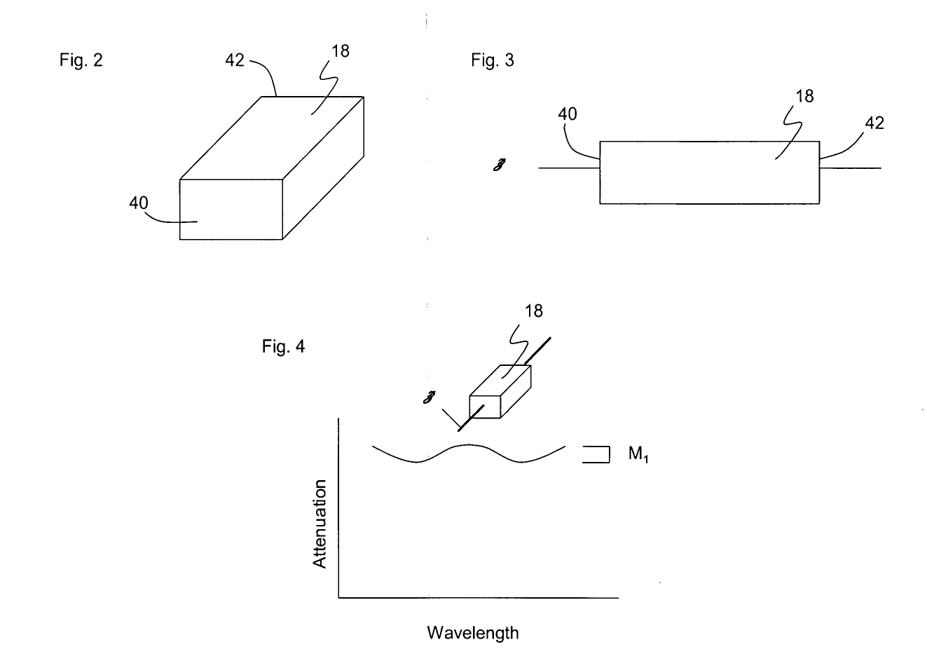

Referring again to the embodiment illustrated in FIG. 1, at least one spectral modification element or pulse broadening device 18 is positioned within the laser system 10. In one embodiment, the spectral modification element 18 may be positioned within the oscillator 12. Optionally, the spectral modification element 18 need not be located within the oscillator 12. As such, the spectral modification element 18 may be positioned between the oscillator 12 and the amplifier 14. Optionally, the spectral modification element 18 may be located within the amplifier 14. Any variety of spectral modification devices or pulse broadening methods may be used. For example, in one embodiment, the spectral modification element comprises un-doped Vandate body having no wedge formed thereon having a length from about 1 mm to about 50 mm. In this embodiment the spectral modification devices functions as a bandwidth restrictive element. FIGS. 2 and 3 show an embodiment of a spectral modification element 18 having a first surface 40 and a second surface 42. As shown, the first and second surfaces 40 and 42 are substantially parallel. In one embodiment the first and second surfaces 40 and 42 are parallel to less than 10 arc-seconds. In another embodiment the first and second surfaces 40 and 42 include AR coatings to minimize back reflections and etalon effects in the oscillator 12. In one embodiment the AR coatings have a reflectivity of less than 0.1%. In another embodiment the AR coatings have a reflectivity of less than 0.05%.

For example, as shown in FIG. 3, the first and second surfaces 40 and 42 may be configured to be perpendicular to the longitudinal axis [symbol] of the spectral modification element 18. Additionally, the optic axis of the crystal is substantially perpendicular to the longitudinal axis, [symbol] Optionally, any variety of materials having large birefringence may be used to manufacture the spectral modification element 18. Optionally, any birefringent material may be used. Other exemplary materials include without limitation, quartz α-BBO, calcite, KBBF, KGW, KYW and the like. Optionally other crystal orientations may also be used. In one embodiment where the spectral modification device contains birefringent material, the signal or beam incident upon the spectral modification element 18 may be substantially linearly polarized. As such, the spectral modification device 18 may also contain a polarization analyzer set to pass light that is substantially linearly polarized.

In one embodiment the substantially linearly polarized beam incident upon the spectral modification element is provided via the laser gain material, such as but without limitation, an Nd:YVO₄ crystal. In this embodiment the Nd:YVO₄ crystal provides gain for a preferred polarization direction. As such, the Nd:YVO₄ gain crystal also acts as the polarization analyzer. It will be apparent to those skilled in the art that other gain materials may be used as well. Exemplary other gain materials may include, without limitation, one or more than one gain material selected from the list: Ti:sapphire, Gd:YVO₄, Nd:YAG, Nd:YLF, Nd:Glass, Cr:YAG, Cr:Forsterite, Yb:YAG, Yb:glass, Yb:KGW, Yb:KYW, KYbW, YbAG, apatite structure crystals, gases, alkali vapors, and the like. It will also be apparent that the polarization analyzer might consist of one or more than one of any polarization selective element such as, without limitation: absorptive polarizers, birefringent polarizers, reflection polarizers, polarizing cubes, Brewster elements, thin-film polarizers, wire-grid polarizers, and the like.

In one embodiment, the spectral modification element 18 is positioned on a rotatable or gimbaled optical mount (not shown) known in the art. For example, the spectral modification element 18 positioned on multi-axis gimbaled optical mount may be configured to be rotatable about and/or tiltable with respect to the longitudinal axis [symbol] of a signal or beam incident upon the spectral modification element 18. FIG. 4 shows the wavelength transmission spectrum of spectral modification element 18 used in the laser system 10 (See FIG. 1) having the spectral modification element 18 having a first orientation wherein the incident signal is parallel to the longitudinal axis [symbol] of the spectral modification element 18. As shown, the wavelength transmission spectrum has a first modulation depth M₁.

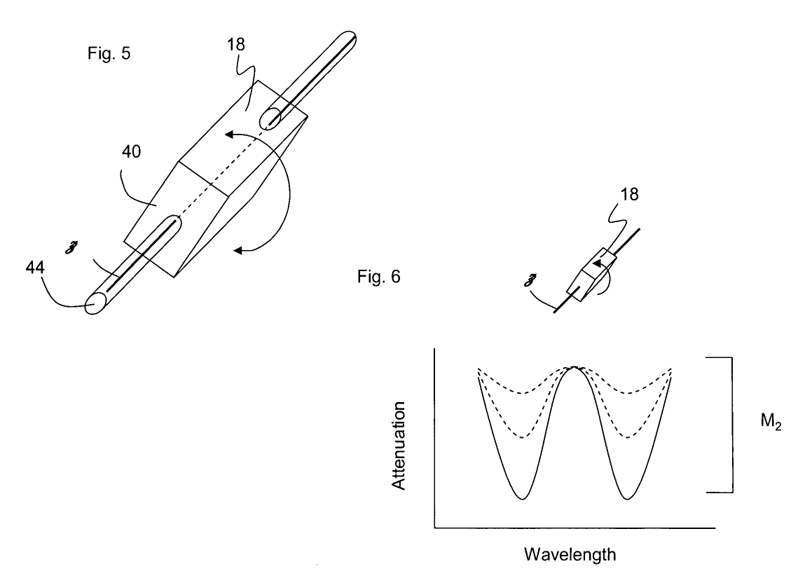

In contrast, FIG. 5 shows an embodiment of a spectral modification element 18 rotated about its longitudinal axis [symbol] wherein an incident laser signal 44 is parallel to the longitudinal axis [symbol] of the spectral modification element 18, such that the incident signal 44 and the longitudinal axis [symbol] are perpendicular to the first surface 40 of the spectral modification element 18. As shown in FIG. 6, the output wavelength spectrum of the embodiment shown in FIG. 5 includes a greater modulation depth M₂ than the modulation depth M₁ shown in FIG. 4. As such, the modulation depth of the wavelength transmission spectrum may be selectively increased or deceased by a user by rotating the spectral modification element 18 about its longitudinal axis

[symbol]

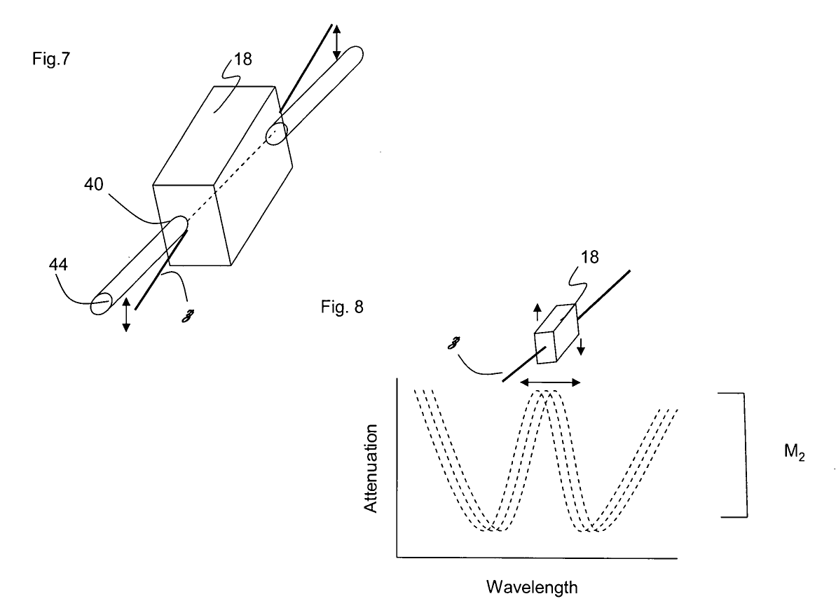

In addition, the multi-axis optical mount may be configured to tilt the spectral modification element 18. FIG. 7 shows an alternate embodiment wherein the spectral modification element 18 is tilted with respect to the incident signal 44 such that the longitudinal axis [symbol] of the spectral modification element 18 and the incident signal 44 are not parallel. As shown in FIG. 8, the modulation depth M₂ of the wavelength transmission spectrum reflects the rotated orientation of the spectral modification element 18. However, the introduction of tilt into the system results in a wavelength shifting of the modulation function of the wavelength transmission spectrum. As such, the user may minimize the loss for a desired wavelength by increasing or decreasing the tilt of the spectral modification element 18 relative to an incident beam. Optionally, the multi-axis optical mount may be movable along the X axis, Y axis, Z axis, or any combination thereof. Further, the multi-axis optical mount may include one or more piezoelectric drive elements, magneto-restrictive drive elements, worm drives, and the like.

Referring again to FIG. 1, in one embodiment spectral modification element 18 is included in oscillator 12 as shown. In this embodiment oscillator 12 is a Vanguard™ oscillator. The oscillator 12 contains a Nd:vanadate gain material and is diode pumped at a wavelength of about 808 nm with a pump power of about 7 W. In one embodiment, the oscillator 12 produces about 3 W of output power at a wavelength of about 1064 nm. Further, the oscillator 12 may be modelocked using a SESAM, and produces pulses having durations of about 25 ps. The spectral modification element 18 may be comprised of un-doped Vanadate having a length along longitudinal axis [symbol] of about 8 mm and transverse dimensions of about 4 mm. The spectral modification element 18 may be inserted into the oscillator 12 and cause the oscillator 12 to produce pulses having durations of about 50 ps. Optionally, the spectral modification element 18 can be configured to cause the oscillator 12 to produce pulses having durations between about 25 ps and about 80 ps. Further, the spectral modification element 18 may be configured to cause the oscillator 12 to produce pulses having durations greater than about 50 ps. Further, the spectral modification element 18 can be positioned to cause the oscillator 12 to produce pulses having durations greater than about 65 ps.

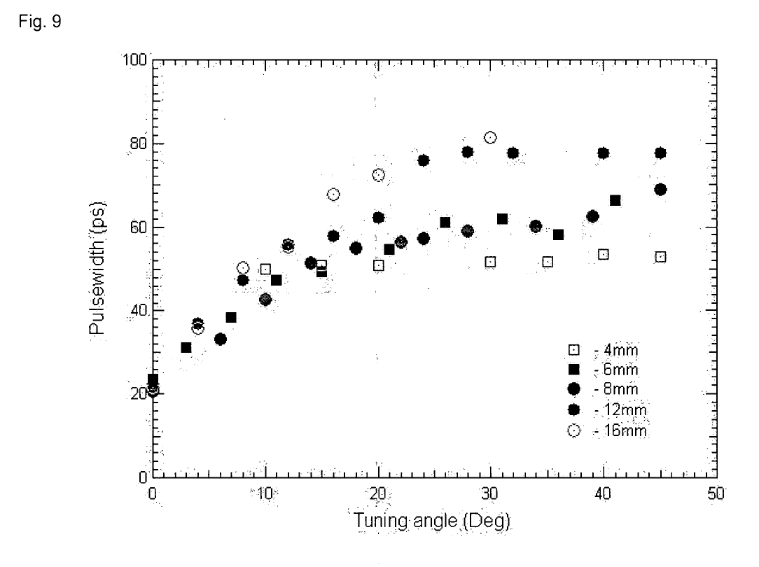

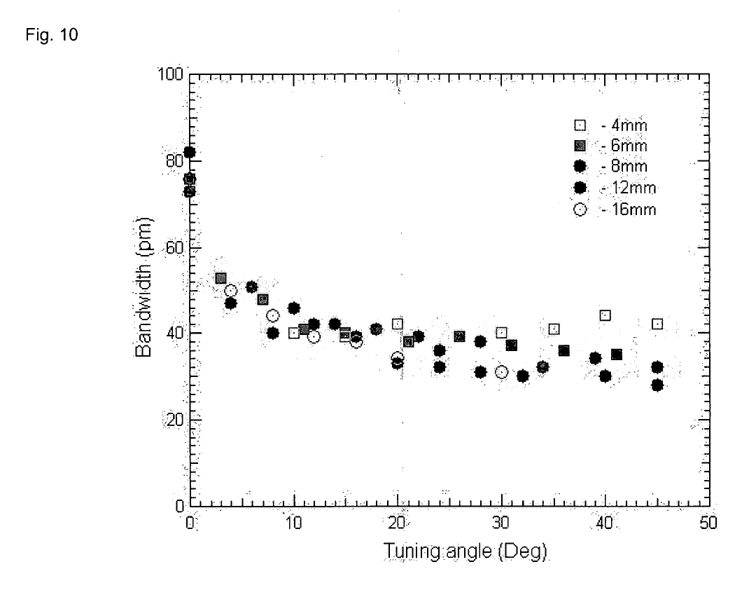

FIG. 9 shows the variation in pulse duration at the output 30 of oscillator 12 having spectral modification elements 18 of various lengths positioned therein (See FIG. 1). As shown in FIG. 9 and described above, the pulsewidth of the output 30 of the oscillator 12 may be varied by adjusting the angle of the spectral modification element 18 relative to the incident beam, for several different longitudinal lengths of spectral modification element 18. Similarly, FIG. 10 shows the variation in bandwidth of the output 30 of oscillator 12 when spectral modification element 18 of various lengths is similarly varied. As shown, the bandwidth of the output 30 may be varied by adjusting the angle of the spectral modification element 30.

Optionally, various elements for pulse broadening or bandwidth restriction elements 18 may be used. Further, multiple pulse broadening and/or spectral modification elements may be used in the laser system 10. In another embodiment, the spectral modification element 18 comprises an acousto-optic modulator coupled to a variable RF power supply, thereby providing an active mode-locking system with variable modulation. Further, the spectral modification element 18 may comprise one or more etalons positioned inside or outside or inside and outside the oscillator 12. Optionally, other elements for pulse broadening or bandwidth restriction may be used, such as, but not limited to, individual elements or combinations of elements that include masks, slits, liquid-crystal spatial light modulators, acousto-optic programmable dispersive filters, and the like. In another embodiment, where the oscillator 12 is a fiber oscillator, the spectral modification element 18 may comprise an appropriately chosen length of birefringent fiber that is appropriately orientated and integrated into the system.

Referring again to FIG. 1, the laser system 10 may include one or more optical elements therein. The optical elements 20 may be configured to modify at least one optical signal within the laser system 10. For example, the optical element 20 may comprise one or more lenses configured to focus an optical signal from the oscillator 12 into a fiber amplifier 14. In another embodiment, the optical element 20 comprises an acousto-optic modulator. Any variety and combination of optical elements 20 may be included within the laser system 10 or in optical communication therewith, including, without limitation, lenses, acousto-optical modulators, acousto-optic programmable dispersive filters, signal modulators, waveplates, etalons, gratings, mirrors, filters, polarizers, Brewster windows, windows, and the like.

As shown in FIG. 1, one or more optical suites 22 may be coupled in optical communication with the laser device 10. Typically, the optical suite 22 is configured to receive an output 34 from the laser system 10 and modify it to produce an optical signal 36 with a desired property or set of properties. For example, in one embodiment, the optical suite 22 may be configured to produce a quasi-CW UV beam having a desired spot size. In one embodiment a desired spot size is about 1 micron to about 50 microns. Optionally, the optical suite 22 may include one or more lenses, mirrors, modulators, scanners, gratings, etalons, windows, spatial filters, and the like. In the illustrated embodiment, the optical suite 22 is positioned external of the laser system 10. Optionally, the optical suite 22 may be positioned within the laser system 10. Further, both the laser system 10 and the optical suite 22 may be located within a single housing 24. Optionally, the housing 24 might include other equipment. For example, the housing 24 might optionally completely enclose laser system 10, optical suites 22, and optical signal 36, or various elements thereof.

During use, the oscillator 12 irradiates an optical signal 30 at a first wavelength through the spectral modification element 18 to the amplifier device 14. For example, the wavelength of the optical signal 30 may be about 1064 nm, although those skilled in the art will appreciate that the first optical signal 30 may have any wavelength. Thereafter, the amplifier device 14 amplifies the optical signal 30 thereby producing an amplified signal 32, which is directed to the harmonic conversion device 16, which converts the amplified optical signal 32 at a first wavelength to at least a second wavelength. Thereafter, the wavelength converted signal 34 is outputted to the optical suite 22 which modifies the wavelength converted signal 34 and outputs a modified output signal 36.

As described above, in one embodiment the user may rotate or otherwise alter the orientation of the spectral modification element 18 relative to the signal irradiated by the oscillator 12 to increase or decrease the modulation depth (see FIGS. 4 and 6) of the wavelength transmission spectrum produced by the spectral modification element 18 in communication with laser system 10. Further, the user may tune the wavelength of the modulation variation (See FIG. 8) by increasing or decreasing the tilt of the spectral modification element 18 relative to an incident beam from the oscillator 12. As a result, the user may effectively tune the output of the laser system 10 to provide an output having a desired output wavelength spectrum or other optical characteristic. For example, the user may adjust the rotation and tilt of the spectral modification element 18 to increase or decrease output spot size, beam quality (i.e. M²), bandwidth, pulse duration, peak power, and the like. Therefore, unlike prior art systems, the present system may be configured to optimize optical suite performance 22, harmonic conversion efficiency, beam properties, peak power, pulse width, or any combination thereof.

For example, in many harmonic conversion processes, the bandwidth of the input signal that can be efficiently converted is limited by the phase-matching bandwidth of the harmonic conversion device, and this is well known by those skilled in the art. However, it is not well appreciated that the beam quality of the harmonic output can also be degraded if the bandwidth of the input is too broad, and that this effect occurs before there is a significant decrease in conversion efficiency. Thus, the device disclosed herein can be used to control the M² of the harmonic output 34 by adjusting the bandwidth of the input 30. Since the bandwidth at the output 32 of the amplifier depends both on the input 30 bandwidth and the input 30 peak power, the method disclosed herein is particularly effective since the input pulse duration is increased while the input bandwidth is reduced.

Additionally, the present invention can optionally be used to optimize some aspect of the end process, rather than, or in addition to, the optical suite 22 performance. For example, the peak power of the output signal 36 could be optimized for applications where too much peak power would cause damage or other detrimental effects to the work-pieces.

The various embodiments disclosed herein are illustrative of the principles of the invention. Other modifications may be employed which are within the scope of the invention. Accordingly, the devices disclosed in the present application are not limited to that precisely as shown and described herein.

What is claimed is:

1. A method of optimizing at least one characteristic of the output of a laser system, comprising:
providing a laser system having at least one spectral modification element in optical communication therewith;
determining at least one optical characteristic of the output of the laser system for a given application;
selecting the wavelength spectrum of the output of the laser system to provide the determined characteristic; and
adjusting the spectral modification element to provide the selected wavelength spectrum.

2. The method of claim 1 wherein the optical characteristic is bandwidth.

3. The method of claim 1 wherein the optical characteristic is pulse width.

4. The method of claim 1 wherein the optical characteristic is output spot size.

5. The method of claim 1 wherein the optical characteristic is output M-squared.

6. The method of claim 1 wherein the optical characteristic is peak power.

7. The method of claim 1 wherein the optical characteristic is wavelength.

8. The method of claim 1 wherein the spectral modification element is adjusted by rotating the spectral modification element about its longitudinal axis.

9. The method of claim 1 wherein the spectral modification element is adjusted by tilting the spectral modification element such that a beam incident thereon intersects the longitudinal axis of the spectral modification element.

10. The method of claim 1 wherein the laser system comprises a quasi-CW UV laser.

11. The method of claim 1 wherein the laser system comprises harmonically tripled laser.

12. The method of claim 1 wherein the laser system includes a picosecond quasi-CW UV laser.

13. The method of claim 1 wherein the laser system includes at least one fiber amplifier.

14. A method of varying the output of a laser system, comprising:
providing a laser system comprising at least one oscillator having at least one spectral modification element in optical communication therewith;
selecting the pulse width of the output of the laser; and
adjusting the position of the spectral modification element relative to an optical signal received from the oscillator to provide the selected pulse width.

15. The method of claim 14 wherein the spectral modification element is adjusted by rotating the spectral modification element about its longitudinal axis.

16. The method of claim 14 wherein the spectral modification element is adjusted by tilting the spectral modification element such that a beam incident thereon intersects the longitudinal axis of the spectral modification element.

17. The method of claim 14 wherein the laser system comprises a quasi-CW UV laser.

18. The method of claim 14 wherein the laser system comprises a harmonically tripled laser.

19. The method of claim 14 wherein the laser system includes a picosecond quasi-CW UV laser.

20. The method of claim 14 wherein the laser system includes at least one fiber amplifier.

21. A laser system, comprising:
at least one oscillator configured to output an oscillator signal having a first optical characteristic;
at least one spectral modification element in optical communication with the oscillator and configured to receive the oscillator signal and output a modified signal having a modified optical characteristic; and
at least one amplifier in communication with at least one of oscillator and the spectral modification element and configured to receive at least one of the oscillator signal and the modified signal, the amplifier configured output an amplified signal having a desired optical characteristic.

22. The device of claim 21 wherein the optical characteristic of the amplified signal is the bandwidth.

23. The device of claim 21 wherein the optical characteristic of the amplified signal is the pulsewidth.

24. The device of claim 21 wherein the optical characteristic of the amplified signal is the spot size.

25. The device of claim 21 wherein the optical characteristic of the amplified signal is the M-squared.

26. The device of claim 21 wherein the optical characteristic of the amplified signal is the peak power.

27. The device of claim 21 wherein the optical characteristic of the amplified signal is the wavelength.

28. The device of claim 21 wherein the oscillator comprises at least one oscillator selected from the group consisting of picosecond oscillators, femtosecond oscillators, diode-pumped Nd:Vanadate devices, mode-locked devices, non-modelocked devices, diode lasers, diode pumped solid state lasers, gas lasers, disk lasers, slab laser, VCSEL lasers, alkali lasers, silicon lasers, fiber lasers, CW lasers, Quasi-CW lasers, Q-switched lasers, single frequency laser systems, and OPOs.

29. The device of claim 21 wherein the spectral modification element includes a body manufactured from the group consisting of undoped Vanadate, quartz, α-BBO, calcite, KBBF, KGW, and KYW.

30. The device of claim 21 wherein the amplifier is selected from the group consisting of fiber amplifiers, bulk amplifiers, bulk waveguide amplifiers, and semiconductor amplifiers.

31. The device of claim 21 further comprising at least one frequency conversion device in optical communication with the oscillator.

32. The device of claim 31 wherein the frequency conversion device is selected from the group consisting of second harmonic generators, third harmonic generators, fourth harmonic generators, fifth harmonic generators, sixth harmonic generators, optical-parametric generators, optical-parametric oscillators, difference-frequency mixers, sum-frequency mixers, LBO devices, non-critically phase matched LBO devices, LiNbO₃ devices, LiTaO₃ devices, BBO devices, BiBO devices, CLBO devices, KTP devices, KTA devices, RTA devices, CTA devices, KDP devices, AgGaSe₂ devices, AgGaS₂ devices, PPLN devices, PPLT devices, PPSLT devices, aperiodically poled materials, parametric conversion devices, continuum generators, nonlinear conversion devices, THz generators, and atomic and molecular gasses and plasmas.

33. The device of claim 21 wherein the oscillator comprises a modelocked Nd:vanadate oscillator, the spectral modification element comprises an un-doped vanadate body, the amplifier comprises a fiber amplifier, and the optical characteristic of the amplified signal is the pulse width.

34. The device of claim 33 further comprising at least one third harmonic generator comprising one or more LBO devices is optical communication with at least one of the oscillator, the spectral modification element, and the amplifier.

35. The device of claim 33 further being configured to produce a quasi-cw UV output having an M-squared less than about 1.5 and a bandwidth less than about 100 picometer.

36. The device of claim 33 further being configured to produce a quasi-cw UV output having an M-squared less than about 1.5 and a bandwidth less than about 50 picometers.
